(19) United States
(12) Patent Application Publication
(10) Pub. No.: US 2011/0143102 A1
(43) Pub. Date: Jun. 16, 2011

(54) Freedom flag

(76) Inventor: Anthony Luciano, Walnut, CA (US)

(21) Appl. No.: 12/927,958

(22) Filed: Nov. 30, 2010

Related U.S. Application Data
(60) Provisional application No. 61/283,936, filed on Dec. 10, 2009.

(51) Int. Cl. B32B 3/10

(52) U.S. Cl. 428/195.1

(57) ABSTRACT

The present invention, hereinafter referred as the Freedom Flag is a specially designed window tint for motor vehicles which is adorned with a striking image of, in one embodiment, the American flag. Notably, imprinted over the top of the flag and facing forward with wings outstretched is the bald eagle, providing a bold and striking contrast to the flag design. The flag itself is rendered as the traditional stars and stripes and as such would boast a blue union adorned with fifty stars positioned in the upper left quadrant of the flag and features thirteen horizontal strips of alternate red and white. The Freedom Flag is rendered to create the illusion that the flag is freely flying, thus the bottom of the union and stripes are rendered as undulating, waving lines. Boldly imprinted on the left side of the unit are the words “STRENGTH,” “HONOR,” “FREEDOM” rendered in a cursive text and boasting a stepped placement. As mentioned, the Freedom Flag is produced as a standard vehicle sun blocker, thus this image could be imprinted on window tint to block the ultraviolet rays of the sun from the rear window.

### CLAIM OF PRIORITY

This patent application claims priority under 35 USC 119 (e) (1) from U.S. Provisional Patent Application Ser. No. 61/283,936 filed Dec. 10, 2009, of common inventorship herewith entitled, “Freedom Flag.”

### FIELD OF THE INVENTION

The present invention pertains to the field of automobile sun screens, and more specifically to the field of decorative automobile window sun screens.

### BACKGROUND OF THE INVENTION

The prior art has put forth several designs for decorative automobile sun screens. Among these are:

U.S. Pat. No. 4,751,115 to James P. Smith and Virginia R. Lloyd describes a reflective sun screen for use in an automobile which is disclosed herein having a rectangular heat absorbing board scored at selected spaced apart locations across its length so as to be folded over upon itself in accordion-style fold for storage purposes. A reflective film having graphic renderings is laminated to a surface of the board and provides irregular surface areas of translucent sections so that varying reflective surface portions appear on the surface. The screen constitutes a graphic poster having solar heat absorption characteristics.

U.S. Pat. No. 5,064,239 to Charles P. Folcik describes a sunscreen for a motor vehicle window which includes a sheet of flexible stretchable, opaque material that has a weave that is adapted to adhere directly to the hook portion of a hook and loop fastener, the sheet of material having a slit therein for accommodating a rear view mirror.

U.S. Pat. No. 6,135,193 to Virginia R. Lloyd describes a sunscreen having a plurality of hinged panels deployed with respect to one another in order to provide an elongated integral panel in an operative position installable across an auto or dwelling window. The external surface of the sunscreen caries a reflective and heat absorption foil surface which carries translucent and opaque portions formed by the presence of graphic subject matter.

None of these prior art references describe the present invention.

### SUMMARY OF THE INVENTION

It is an object of the present invention to provide decorative automobile window sun block.

### BRIEF DESCRIPTION OF THE DRAWINGS

FIG. 1 is an elevational angled perspective view of the device of the present invention.

FIG. 2 is a front perspective view of an alternative embodiment of the present invention.

FIG. 3 is a front perspective view of another alternative embodiment of the present invention.

FIG. 4 is a front perspective view of another alternative embodiment of the present invention.

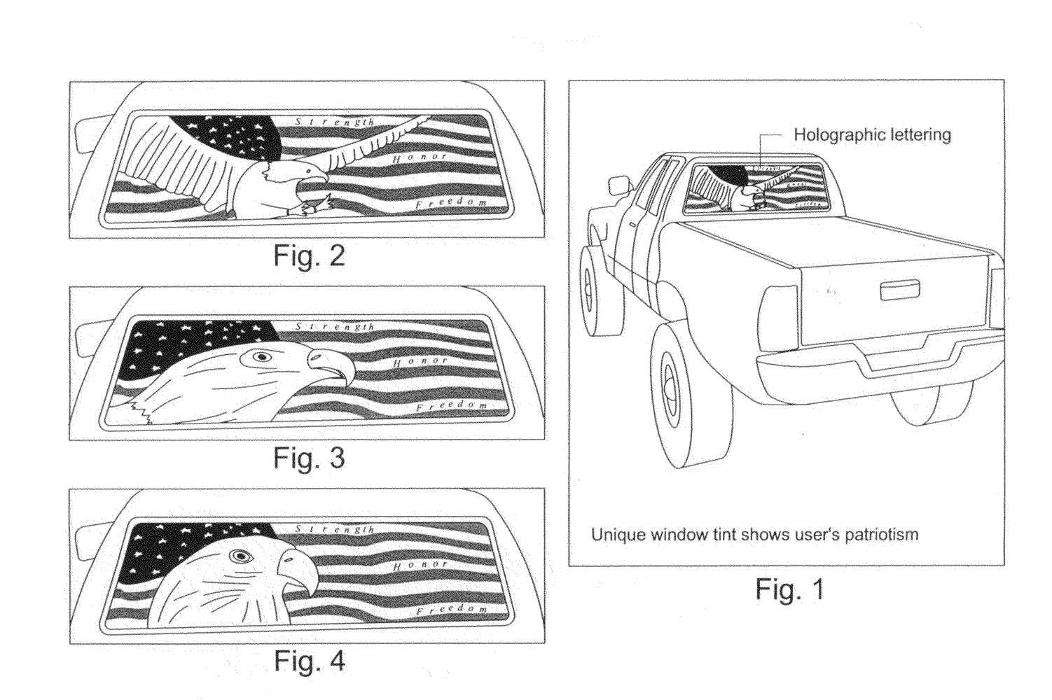

### DETAILED DESCRIPTION OF THE INVENTION

A national symbol of enduring freedom is the flag. Representing the struggle for independence, the unity of a nation and the liberty shared by the people, the national flag is an inspiration during times of hardship and a constant reminder of the valor and devotion of those who have sacrificed their lives for a nation. Flags have flown on battlefields, atop government buildings, in front of schools and even on the moon. Today, more than ever before, citizens are embracing the flag and displaying with pride this glorious symbol of freedom. A common way in which people display the flag is on their vehicles. In fact, adhesive flag stickers, flag magnets and small, plastic or fabric window flags are very popular with motorists across the country.

The present invention, hereinafter referred as the Freedom Flag is a specially designed window tint for motor vehicles which is adorned with a striking image of, in one embodiment, the American flag. Notably, imprinted over the top of the flag and facing forward with wings outstretched is the bald eagle, providing a bold and striking contrast to the flag design. The flag itself is rendered as the traditional stars and stripes and as such would boast a blue union adorned with fifty stars positioned in the upper left quadrant of the flag and features thirteen horizontal strips of alternate red and white. The Freedom Flag is rendered to create the illusion that the flag is freely flying, thus the bottom of the union and stripes are rendered as undulating, waving lines. Boldly imprinted on the left side of the unit are the words “STRENGTH,” “HONOR,” “FREEDOM” rendered in a cursive text and boasting a stepped placement. As mentioned, the Freedom Flag is produced as a standard vehicle sun blocker, thus this image could be imprinted on window tint to block the ultraviolet rays of the sun from the rear window. This product is produced in a variety of sizes for installation in compact, midsize and luxury cars and trucks. The Freedom Flag line also includes a permanent window shade, adhesive stickers, magnets and a myriad of other printed goods. As can be imagined, design possibilities for this patriotic accessory are virtually limitless.

There are many benefits and advantages associated with the Freedom Flag. Foremost, the Freedom Flag allows consumers to display the nation's flag when driving their vehicles, providing a simple way in which to express their patriotism. A beautiful rendering of the flag adorned with the image of a bald eagle and the thought provoking sentiments of Strength, Honor, Freedom, the Freedom Flag provides consumers a practical way of honoring the sacrifices of troops at war and those who have gone before and have given much for this great land. Not limited to American Flags, the Freedom Flag logo is applied to any number of goods, from stickers to magnets, to mugs and T-shirts, providing almost endless possibilities for celebrating national pride.

The Freedom Flag provides consumers a simple and efficient means of protecting their vehicles from the intense glare of the sun. Completely encompassing the automobile rear window, use of the Freedom Flag offers a practical means of controlling the temperature inside and preventing glare. Consumers appreciate that the Freedom Flag prevents the interior temperature of the car from rising to extreme levels, thereby protecting contents stored within the car, as well as the automobile itself. Saving the user the expense of replacing cosmetics, compact discs and other personal items, the Freedom Flag proves an invaluable accessory for any car owner. Versatile, the Freedom Flag is easily installed in virtually any make and model vehicle. Durably constructed of quality materials, the Freedom Flag withstands years of repeated use.

The Freedom Flag is a practical product invention which provides consumers a simple and effective means of celebrating a love of country and which also serves to keep their cars cool and comfortable during the hot days of summer. Innovative and unique, this cleverly designed window tint proves an invaluable commodity for anyone who owns an automobile.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A decorative automobile sun screen, comprising: a window tint for mounting on the window of a motor vehicle which is adorned with a striking image.

2. The decorative sun screen of claim 1 wherein the image is the American flag.

3. The decorative sun screen of claim 1, wherein the image is an American Flag and over the top of the flag and facing forward with wings outstretched is a bald eagle.

4. The decorative sun screen of claim 1 further comprising the words “STRENGTH,” “HONOR,” “FREEDOM.”
